(19) United States
(12) Patent Application Publication
(10) Pub. No.: US 2026/0154941 A1
(43) Pub. Date: Jun. 4, 2026

(54) METHOD AND DEVICE WITH IMAGE-TEXT PAIR GENERATION

(71) Applicant: Samsung Electronics Co., Ltd., Suwon-si (KR)

(72) Inventors: Junsang YU, Suwon-si (KR); Jisoo SON, Suwon-si (KR); Kinam KWON, Suwon-si (KR); Sanghyun SON, Suwon-si (KR); Eunhee KANG, Suwon-si (KR); Geonseok SEO, Suwon-si (KR); Nagyeong LEE, Suwon-si (KR); Hyong Euk LEE, Suwon-si (KR)

(73) Assignee: Samsung Electronics Co., Ltd., Suwon-si (KR)

(21) Appl. No.: 19/201,861

(22) Filed: May 7, 2025

(30) Foreign Application Priority Data
Nov. 29, 2024 (KR) 10-2024-0175846

(51) Int. Cl. G06V 10/74; G06V 10/75; G06V 20/70; G06V 30/19; G10L 15/26

(52) U.S. Cl. CPC G06V 10/761; G06V 10/751; G06V 20/70; G06V 30/19093; G10L 15/26

(57) ABSTRACT

A processor-implemented method includes generating, from a video comprising speech data and a plurality of frame images, a first content set comprising a partial speech and a representative frame image, separating a digital document related to the video into a plurality of candidate content sets, mapping a second content set among the candidate content sets, which is related to the first content set, to the first content set, generating text corresponding to the representative frame image of the first content set, based on the first content set and the second content set, and generating an image-text pair comprising the representative frame image and the generated text.

### CROSS-REFERENCE TO RELATED APPLICATIONS

This application claims the benefit under 35 USC § 119(a) of Korean Patent Application No. 10-2024-0175846, filed on Nov. 29, 2024 in the Korean Intellectual Property Office, the entire disclosure of which is incorporated herein by reference for all purposes.

### BACKGROUND

### 1. Field

The following description relates to a method and device with image-text pair generation.

### 2. Description of Related Art

Generation of an image-text pair may be technology for converting visual information of an image into text and matching the image to the text and may play an important role in various fields such as image search, description generation, and automatic tagging. Generation of an image-text pair may be performed by utilizing a large-scale image and text dataset through a deep learning model such as a convolutional neural network (CNN) and a recurrent neural network (RNN). A CNN may be used to extract features from an image, and an RNN may be used to convert the features into text.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes generating, from a video comprising speech data and a plurality of frame images, a first content set comprising a partial speech and a representative frame image, separating a digital document related to the video into a plurality of candidate content sets, mapping a second content set among the candidate content sets, which is related to the first content set, to the first content set, generating text corresponding to the representative frame image of the first content set, based on the first content set and the second content set, and generating an image-text pair comprising the representative frame image and the generated text.

The generating of the first content set may include generating speech text by converting the speech data into text, grouping the plurality of frame images into a plurality of frame image sets, and determining, for each frame image set, a representative frame image of the frame image set and a partial speech corresponding to the frame image set among the speech text as one first content set.

The grouping of the plurality of frame images may include determining a first representative frame image from among the plurality of frame images, and based on a difference between the first representative frame image and a candidate frame image, performing either one of adding the candidate frame image to a first frame image set corresponding to the first representative frame image, or determining the candidate frame image as a second representative frame image representing a second frame image set.

The grouping of the plurality of frame images further may include determining the difference between the first representative frame image and the candidate frame image based on a difference between pixel values of pixels of the determined first representative frame image and pixel values of pixels of the candidate frame image.

The grouping of the plurality of frame images further may include determining, based on a similarity level between first text recognized from the determined first representative frame image and second text recognized from the candidate frame image, the difference between the first representative frame image and the candidate frame image.

The separating of the digital document may include separating the digital document into a plurality of candidate content sets based on either one or both of a page and a section of the digital document.

The separating of the digital document may include adding, for each image of the digital document, text related to a corresponding image to a candidate content that may include the corresponding image.

The separating of the digital document may include adding, for an image included in the digital document, text recognized from the image to a content set that may include the image.

The mapping of the second content set to the first content set may include determining, in response to a candidate content set comprising an image, an image similarity level between the representative frame image of the first content set and the image of the candidate content set, determining, in response to the candidate content set comprising text, a text similarity level between a partial speech of the first content set and the text of the candidate content set, and determining whether to map the candidate content set as the second content set to the first content set, based on either one or both of the determined image similarity level and the determined text similarity level.

The mapping of the second content set to the first content set may include either one or both of mapping two or more second content sets to one first content set, and mapping one second content set to two or more first content sets.

The generating of the text may include generating, by using a text generation model, any one or any combination of any two or more of caption text of the representative frame image, description text of the representative frame image, and question-answer text for the representative frame image.

The generating of the text may include determining an image type of the representative frame image or a partial image of the representative frame image from among a plurality of image types comprising a photo type, a table type, a diagram type, and a graph type, and generating the text based on information on the determined image type.

The method may include training a vision language model by using a training data set comprising the generated image-text pair.

The training of the vision language model may include selecting a target image-text pair from among a plurality of candidate image-text pairs, based on any one or any combination of any two or more of a confidence level, a relevance level, and an image type of each candidate image-text pair, and generating the training data set based on the selected target image-text pair.

The method may include extracting a partial image from the representative frame image of the first content set, and generating the extracted partial image and text corresponding to the partial image as an image-text pair.

In one or more general aspects, a non-transitory computer-readable storage medium may store code that, when executed by one or more processors, configure the one or more processors to perform any one, any combination, or all of operations and/or methods disclosed herein.

In one or more general aspects, a processor-implemented method includes generating candidate content sets from a video comprising speech data and a plurality of frame images, wherein each candidate content set may include a partial speech and a representative frame image, generating a second content set comprising a target image and text related to the target image from a digital document related to the video, mapping a first content set among the candidate content sets, which is related to the second content set, to the second content set, generating text corresponding to the target image of the second content set, based on the first content set and the second content set, and generating an image-text pair comprising the target image and the generated text.

In one or more general aspects, a processor-implemented method includes generating text corresponding to an input image based on a result of applying a vision language model to the input image, wherein the vision language model is trained using a training data set comprising a generated image-text pair, wherein the image-text pair is generated by generating, from a video comprising speech data and a plurality of frame images, a first content set comprising a partial speech and a representative frame image, separating a digital document related to the video into a plurality of candidate content sets, mapping a second content set among the candidate content sets, which is related to the first content set, to the first content set, generating text corresponding to the representative frame image of the first content set, based on the first content set and the second content set, and generating the image-text pair to comprise the representative frame image and the generated text.

In one or more general aspects, an electronic device includes one or more processors configured to generate, from a video comprising speech data and a plurality of frame images, a first content set comprising a partial speech and a representative frame image, separate a digital document related to the video into a plurality of candidate content sets, map a second content set among the candidate content sets, which is related to the first content set, to the first content set, generate text corresponding to the representative frame image of the first content set, based on the first content set and the second content set, and generate an image-text pair comprising the representative frame image and the generated text.

The one or more processors may be configured to generate speech text by converting the speech data into text, group the plurality of frame images into a plurality of frame image sets, and determine, for each frame image set, a representative frame image of the frame image set and a partial speech corresponding to the frame image set among the speech text as one first content set.

Other features and aspects will be apparent from the following detailed description, the drawings, and the claims.

### BRIEF DESCRIPTION OF THE DRAWINGS

FIG. 1 illustrates a flowchart of an example of a method, performed by an electronic device, of generating an image-text pair.

FIG. 2 illustrates an example of an operation in which an electronic device obtains a content set from a video.

FIG. 3 illustrates an example of an operation in which an electronic device obtains a content set from a digital document.

FIG. 4 illustrates an example of an operation in which an electronic device determines a mapping relationship between a first content set and a second content set.

FIG. 5 illustrates an example of an electronic device.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms used herein including technical and scientific terms have the same meanings as those commonly understood by one of ordinary skill in the art to which this disclosure pertains and based on an understanding of the disclosure of the present application. Terms such as those defined in commonly used dictionaries are to be interpreted as having a meaning that is consistent with their meaning in the context of the relevant art and the disclosure of the present application, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Hereinafter, the examples are described in detail with reference to the accompanying drawings. When describing the examples with reference to the accompanying drawings, like reference numerals refer to like components and a repeated description related thereto is omitted.

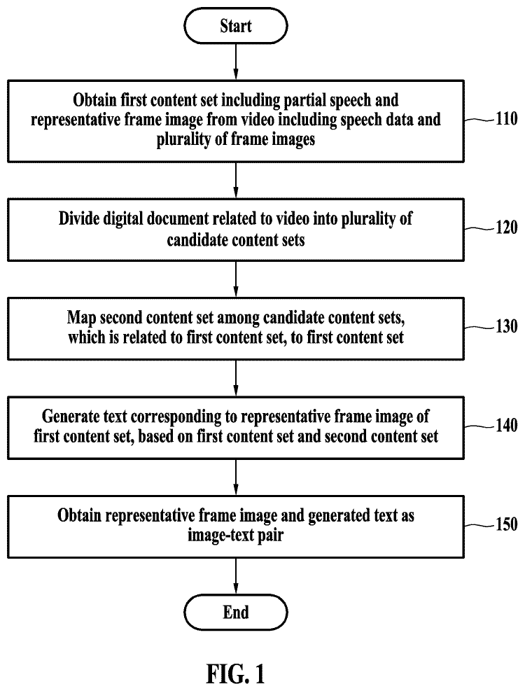

FIG. 1 illustrates a flowchart of an example of a method, performed by an electronic device, of generating an image-text pair. Operations 110 to 150 of FIG. 1 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

The electronic device may generate an image-text pair based on a video and a digital document. The image-text pair may include an image and text corresponding to the image. The image in the image-text pair may be a single frame image included in the video or an image included in the digital document. Hereinafter, an operation in which the electronic device obtains a single frame image of a video as an image of an image-text pair is described first, and an operation in which the electronic device obtains an image of a digital document as an image of the image-text pair is described.

In operation 110, the electronic device may obtain a first content set including a partial speech and a representative frame image from a video.

The video may include speech data and a plurality of frame images. The speech data may refer to a voice signal of a user (or a speaker), obtained (e.g., recorded) in a time interval corresponding to the plurality of frame images.

The first content set may refer to a set of content including content obtained from a portion of the video. The electronic device may obtain a plurality of first content sets from the video. For each of the plurality of first content sets, the electronic device may obtain, by applying operations 110 to 150 illustrated in FIG. 1 to the first content set, an image-text pair from the first content set.

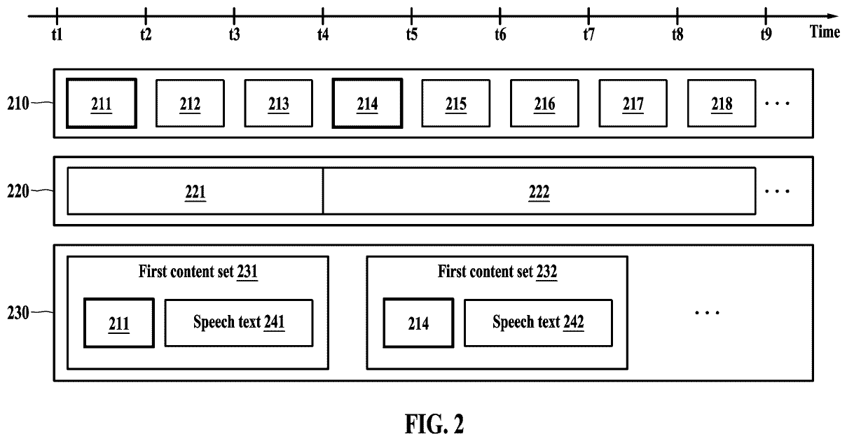

The representative frame image may refer to a frame image selected from among the frame image(s) included in a portion of the video corresponding to the first content set. The representative frame image may be a frame image representing the frame image(s) included in a portion of the video corresponding to a portion of the first content set. The partial speech may refer to text obtained by translating partial speech data included in a portion of the video corresponding to the first content set into text. An example of an operation of obtaining the first content set from the video is described in more detail below with reference to FIG. 2.

In operation 120, the electronic device may divide a digital document related to the video into a plurality of candidate content sets.

The digital document may include one or more images and text. The digital document related to the video may include a digital document that is mapped to the video and/or tagged with information on the video (e.g., a video identifier and/or a video title). For example, when the video is a video recording of a presentation of a presenter, the digital document related to the video may include a reference material (e.g., a paper) and/or a presentation material used in the presentation. The digital document related to the video may include a material that is referenced and/or used as a source in the video, as non-limiting examples.

The digital document may include a document file. For example, the document file may include a text file (e.g., a docx file and/or a txt file), a spreadsheet file (e.g., an xls file, an xlsx file, and/or a csv file), a presentation file (e.g., a ppt file and/or a pptx file), a pdf file, a web document file (e.g., an html file and/or an xml file), a scanned image file of documents, and/or a code file (e.g., a Java file and/or a class file).

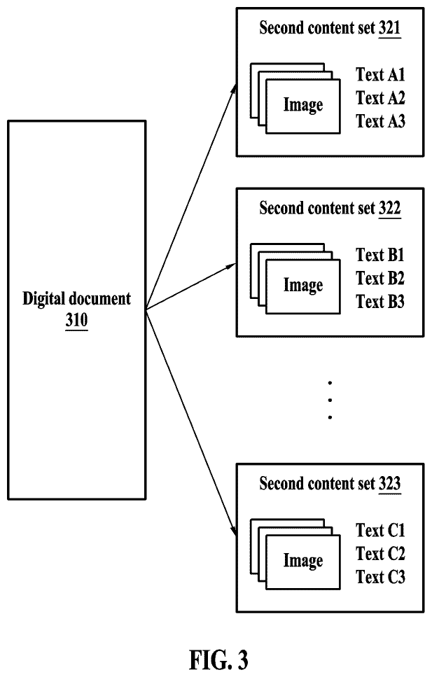

In operation 120, the electronic device may divide image(s) and text(s) obtained from the digital document into the plurality of candidate content sets based on various criteria. An example of the dividing of the digital document into the plurality of candidate content sets is described in more detail below with reference to FIG. 3.

The divided plurality of candidate content sets from the digital document may also be represented as candidate second content sets.

In operation 130, the electronic device may map a second content set among the candidate second content sets, which is related to the first content set, to the first content set.

For example, in operation 130, the electronic device may determine (e.g., select) the second content set related to the first content set from among the candidate second content sets, and the electronic device may map the determined second content set to the first content set.

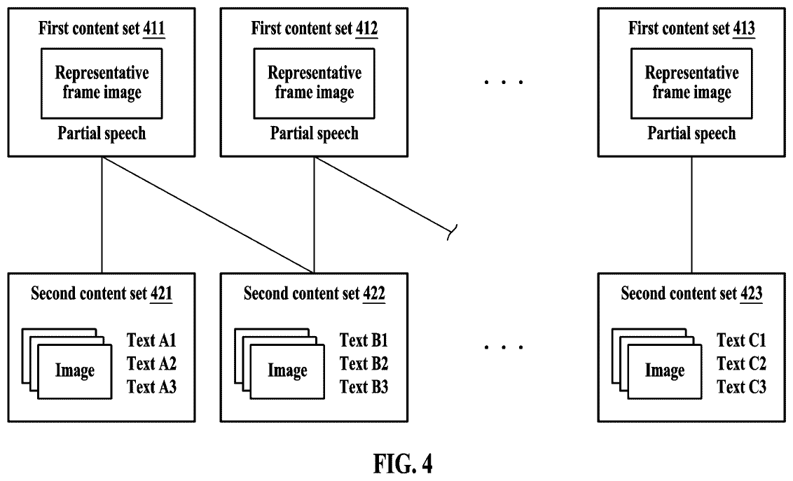

For example, in operation 130, the electronic device may determine the second content set from among the candidate second content sets based on a similarity between images and/or texts included in the candidate second content sets and images and/or texts included in the first content set. An example of an operation of determining a mapping relationship between the first content set and the second content set is described in more detail below with reference to FIG. 4.

In operation 140, the electronic device may generate text corresponding to a representative frame image of the first content set, based on the first content set and the second content set.

For example, in operation 140, the electronic device may generate the text corresponding to the representative frame image of the first content set by using a text generation model. The text generation model may refer to a model that is generated and/or trained to output, from input text including an image and/or content related to the image, text corresponding to the image. The text generation model may be implemented based on at least one of a neural network (e.g., a convolution neural network (CNN)), a transformer, a large language model, a machine learning model, and/or a reinforcement learning model.

The text corresponding to the image (e.g., the representative frame image) may include at least one of caption text of the image (e.g., the representative frame image), description text of the image (e.g., the representative frame image), and/or question-answer text for the image (e.g., the representative frame image).

The caption text may refer to a short text that describes the image (e.g., text including words less than or equal to a threshold number of words). The description text may refer to a long text that describes the image (e.g., text including words more than the threshold number of words). The question-answer text for the image may refer to a text pair composed of a question text inquiring about the image and an answer text including an answer to the question text.

The text generation model may be generated and/or trained to output input text, in response to the input text being available as the text corresponding to the image. A prompt of the text generation model may include outputting input text as is in response to determining that the input text is appropriate as text corresponding to the image.

The electronic device may generate text based on a type of image. An image type of the image (e.g., the representative frame image) may be determined from among a plurality of image types including a photo type, a table type, a diagram type, and a graph type.

The electronic device of the present disclosure is not limited to determining the image type based on the entire image. The electronic device may determine the image type of a partial image of the image among the plurality of image types in response to a partial image of a particular type being included in the image. For example, in response to a graph being included in a portion of the representative frame image, the electronic device may determine a partial image of the representative frame image as a graph type. The electronic device may input information on the partial image (e.g., location information) and information on the image type of the partial image into the text generation model. The electronic device may determine the image type of the representative frame image or the partial image of the representative frame image.

The electronic device may generate text based on information on the determined image type. For example, the electronic device may generate text describing a degree of change indicated in the graph of the image in response to determining the image type as a graph type. For example, the electronic device may generate question-answer text based on a specific item (e.g., a specific column) and a specific entity (e.g., a specific row) of a table, in response to determining the image type as a table type.

In operation 150, the electronic device may obtain the representative frame image and the generated text as an image-text pair.

Referring to FIG. 1, obtaining the entire representative frame image as an image of the image-text pair is mainly described, but examples are not limited thereto. The electronic device may obtain a partial image of the representative frame image as an image of the image-text pair. For example, the electronic device may extract a partial image from the representative frame image of the first content set. The electronic device may generate text corresponding to the partial image, similar to or identical to all or part of operations 110 to 150. The electronic device may obtain the extracted partial image and text corresponding to the partial image as the image-text pair.

As described above, the electronic device may obtain an image included in a digital document as the image of the image-text pair.

The electronic device may obtain candidate content sets from a video including speech data and a plurality of frame images. Each candidate content set may include a partial speech and a representative frame image. The candidate content sets obtained from a video may be referred to as candidate first content sets. Obtaining the candidate first content sets may be performed substantially the same as or similarly to the obtaining of the first content sets. An example of the obtaining of the first content sets (or the candidate first content sets) is described in more detail below with reference to FIG. 2.

The electronic device may obtain a second content set including a target image and text related to the target image from a digital document related to the video. The target image may refer to an image, among images included in the second content set, for generating the image-text pair. The electronic device may determine a partial image of an image included in the second content set as the target image. For example, the electronic device may determine the partial image as the target image based on a result of grouping objects appearing in the image. Obtaining the second content set may be performed in the same or similar manner as obtaining the candidate second content set(s). An example of the obtaining of the second content set (or the candidate second content sets) is described in more detail below with reference to FIG. 3.

The electronic device may map a first content set among the candidate first content sets, which is related to the second content set, to the second content set. In the same or similar manner as in operation 120, the electronic device may determine the first content set from among the candidate first content sets based on a similarity between images and/or texts included in the candidate first content set and images and/or texts included in the second content set. An example of the operation of determining a mapping relationship between the first content set and the second content set is described in more detail below with reference to FIG. 4.

The electronic device may generate text corresponding to the target image of the second content set, based on the first content set and the second content set. The electronic device may obtain the target image and the generated text as the image-text pair. The electronic device may generate text and obtain an image-text pair in the same or similar manner as in operations 140 to 150.

The electronic device may obtain a plurality of second content sets from a digital document. The electronic device may obtain the image-text pair from the second content set by generating text corresponding to a target image of each second content set.

Although not explicitly shown in FIG. 1, the electronic device may use the obtained image-text pair for training a vision language model.

The electronic device may train the vision language model by using a training data set including the obtained image-text pair.

The vision language model may refer to a model that is generated and/or trained to output, from an image, text corresponding to the image. The vision language model may be implemented based on at least one of a neural network (e.g., a CNN), a transformer, a large language model, a machine learning model, and/or a reinforcement learning model.

The electronic device may obtain a plurality of candidate image-text pairs. The electronic device may determine, among the plurality of candidate image-text pairs, a target image-text pair to be used as the training data set for a vision language model. The electronic device may select the target image-text pair from among the plurality of candidate image-text pairs, based on at least one of a confidence level, a relevance level, and/or an image type of each candidate image-text pair. The electronic device may obtain a training data set based on the selected target image-text pair.

The confidence level of a candidate image-text pair may refer to a value indicating a degree to which text of the candidate image-text pair is related to an image of the candidate image-text pair. For example, the confidence level of the candidate image-text pair may refer to a value indicating an extent to which the text is suitable to describe content of the image. For example, the confidence level may be determined as a score (e.g., a real number) or a level (e.g., one of high level, middle level, and low level). For example, the electronic device may select a candidate image-text pair having a confidence level greater than or equal to a threshold confidence level (e.g., a threshold score or a threshold level) as the target image-text pair.

The relevance level of a candidate image-text pair may refer to a value indicating a degree to which the candidate image-text pair is related to the video. For example, the relevance level of a candidate image-text pair may indicate a degree to which the candidate image-text pair is related to content of the entire video. For example, when the video is a result of a recording of a presentation on a particular topic, a candidate image-text pair that includes an image describing part of the particular topic may have a higher relevance level than a candidate image-text pair that includes an image describing information on a presenter. For example, the confidence level may be determined as a score (e.g., a real number) or a level (e.g., one of high level, middle level, and low level). For example, the electronic device may select a candidate image-text pair having a relevance level greater than or equal to a threshold relevance level (e.g., a threshold score or a threshold level) as the target image-text pair.

An image type of a candidate image-text pair may refer to an image type of an image included in the candidate image-text pair. For example, the electronic device may determine the image type of the image from among a plurality of image types, including a photo type, a table type, a diagram type, and a graph type. For example, the electronic device may select a candidate image-text pair including an image of a target type as the target image-text pair.

An inference device may generate text corresponding to an input image based on a result of applying the vision language model to the input image. The inference device is an electronic device that performs inference of the vision language model and may obtain a trained vision language model and generate, from the input image, the text corresponding to the input image. The inference device may be an electronic device that is the same as the electronic device (e.g., a device for obtaining a training data set of the vision language model and/or training the vision language model), and/or may be another electronic device.

The vision language model may be trained using a training data set including an image-text pair. The image-text pair may be obtained by the electronic device according to the present disclosure.

FIG. 2 illustrates an example of an operation in which an electronic device obtains a content set from a video.

The electronic device may obtain one or more content sets 230 from the video. The content set(s) obtained from the video may be referred to as a first content set or a candidate first content set.

The electronic device may group a plurality of frame images into a plurality of frame image sets. The plurality of frame image sets may respectively correspond (e.g., one-to-one) to first content sets.

The electronic device may determine a first representative frame image from among the plurality of frame images. The electronic device may, in response to determining a representative frame image (e.g., the first representative frame image), generate a frame image set including the representative frame image. For example, when there is no frame image selected as the representative frame image from among the plurality of frame images (e.g., initially), the electronic device may determine a frame image corresponding to an earliest timepoint among timepoints corresponding to the plurality of frame images as the first representative frame image.

The electronic device may, based on a difference between the first representative frame image and a candidate frame image, add the candidate frame image to a first frame image set including the first representative frame image, or determine the candidate frame image as a second representative frame image representing a second frame image set.

The candidate frame image may refer to a frame image other than the first representative frame image (e.g., a frame image temporally succeeding the first representative frame image) among a plurality of frame images of the video. The candidate frame image may include a frame image for which a frame image set including the candidate frame image has not been determined.

The electronic device may determine a difference between frame images (e.g., between the first representative frame image and the candidate frame image).

The electronic device may determine the difference between the frame images based on a difference between pixel values. For example, the electronic device may determine a difference between the first representative frame image and the candidate frame image based on a difference between pixel values of pixels of the determined first representative frame image and pixel values of pixels of the candidate frame image. The electronic device may accumulate, across a plurality of pixels, a difference between a pixel value of each of the pixels of the first representative frame image and a pixel value of a corresponding pixel of the candidate frame image. The corresponding pixel of the candidate frame image is a pixel among the pixels of the candidate frame images, which corresponds to the corresponding pixel of the first representative frame image. A specific pixel among the pixels of the first frame image (e.g., the first representative frame image) may correspond to a pixel, among pixels of a second frame image (e.g., the candidate frame image), which has a same position as the specific pixel.

The electronic device may determine the difference between the frame images based on a difference between texts recognized from the frame images. The electronic device may detect text from a frame image by using optical character recognition (OCR) technology. For example, the electronic device may recognize a first text from the first representative frame image. The electronic device may recognize a second text from the candidate frame image. The electronic device may determine the difference between the first representative frame image and the candidate frame image based on a similarity level between the first text and the second text.

The similarity level between the first text and the second text may include a character-level similarity and/or a semantic-level similarity between the first text and the second text. The character-level similarity may indicate a degree to which characters included in the first text are similar to characters included in the second text. The semantic-level similarity may indicate a degree to which a meaning of the first text is similar to a meaning of the second text.

The electronic device may determine the similarity level (e.g., the character-level similarity) between the first text and the second text based on a result of comparing the first text with the second text.

The electronic device may determine the similarity level between the first text and the second text by using a text similarity model. The text similarity model may refer to a model generated and/or trained to output, from input data corresponding to the first text and the second text, output data corresponding to the similarity level (e.g., the semantic-level similarity) between the first text and the second text. The text similarity model may be implemented based on at least one of a neural network (e.g., a CNN), a transformer, a large language model, a machine learning model, and/or a reinforcement learning model.

The electronic device may determine, based on the determined difference, a frame image set to include the candidate frame image.

For example, when the difference between the first representative frame image and the candidate frame image is less than a threshold difference, the electronic device may add the candidate frame image to the first frame image set including the first representative frame image.

For example, when the difference between the first representative frame image and the candidate frame image is greater than or equal to the threshold difference, the electronic device may determine the candidate frame image as a new representative frame image (e.g., the second representative frame image). In an example, when the difference between the first representative frame image and the candidate frame image is greater than or equal to the threshold difference, and when the candidate frame image is the next temporally subsequent frame after a frame included in the first frame image set, the electronic device may determine the candidate frame image as the second representative frame image. The electronic device may, in response to determining the candidate frame image as the second representative frame image, generate the second frame image set including the second representative frame image. The electronic device may compare the second representative frame image with a new candidate frame image (e.g., a frame image that is temporally subsequent to the second representative frame image). The electronic device may determine, based on a difference between the second representative frame image and the new candidate frame image, whether to add the new candidate frame image to the second frame image set or determine the new candidate frame image as a third representative frame image.

Referring to FIG. 2, the video may include a plurality of frame images 210 and speech data 220.

The electronic device may determine a first frame image 211 as the first representative frame image and add the first frame image 211 to the first frame image set. The electronic device may add a second frame image 212 and a third frame image 213 to the first frame image set, in response to a difference between the first frame image 211 and the second frame image 212 being less than the threshold difference and a difference between the first frame image 211 and the third frame image 213 being less than the threshold difference.

The electronic device may, in response to a difference between the first frame image 211 and a fourth frame image 214 being greater than or equal to the threshold difference, determine the fourth frame image 214 as a second representative frame image and generate the second frame image set including the fourth frame image 214. The electronic device may add a fifth frame image 215, a sixth frame image 216, a seventh frame image 217, and an eighth frame image 218 to the second frame image set, in response to a difference between the fourth frame image 214 and the fifth frame image 215 being less than the threshold difference, a difference between the fourth frame image 214 and the sixth frame image 216 being less than the threshold difference, a difference between the fourth frame image 214 and the seventh frame image 217 being less than the threshold difference, and a difference between the fourth frame image 214 and the eighth frame image 218 being less than the threshold difference.

As a result, the electronic device may group the first frame image 211, the second frame image 212, and the third frame image 213 into the first frame image set, and determine the first frame image 211 as the first representative frame image of the first frame image set. The electronic device may group the fourth frame image 214, the fifth frame image 215, the sixth frame image 216, the seventh frame image 217, and the eighth frame image 218 into the second frame image set, and determine the fourth frame image 214 as the second representative frame image of the second frame image set.

The electronic device may determine a partial speech for each frame image set. The electronic device may obtain speech text by converting speech data of a video into text. The electronic device may convert the speech data into the speech text by using speech to string (STT) technology.

The speech data and/or the speech text may be divided based on a time period or a timepoint corresponding to each frame image. The electronic device may determine, for each frame image set, a partial speech corresponding to each frame image set among the speech text as a partial speech for the frame image set. A partial speech corresponding to a specific frame image set may refer to a portion of a timepoint or time interval corresponding to each frame image included in a specific frame image set among the speech text.

The electronic device may determine, for each frame image set, a representative frame image of the frame image set and a partial speech corresponding to the frame image set among the speech text as one first content set.

Referring to FIG. 2, the electronic device may determine a time interval (e.g., from a first timepoint t1 to a fourth timepoint t4) corresponding to the first timepoint t1, a second timepoint t2, and a third timepoint t3, which respectively correspond to the first frame image, the second frame image, and the third frame image included in the first frame image set. The electronic device may determine partial speech data 221 of a time interval among the speech data 220 as a portion for the first frame image set. The electronic device may obtain speech text 241 based on the partial speech data 221. The electronic device may obtain a representative frame image (e.g., the first frame image 211) and the speech text 241 of the first frame image set as one first content set 231.

The electronic device may determine a time interval (e.g., from the fourth timepoint t4 to a ninth timepoint t9) corresponding to the fourth time point t4, a fifth timepoint t5, a sixth timepoint t6, a seventh timepoint t7, and an eighth timepoint t8, which respectively correspond to the fourth frame image, the fifth frame image, the sixth frame image, the seventh frame image, and the eighth frame image included in the second frame image set. The electronic device may determine partial speech data 222 of a time interval among the speech data 220 as a portion for the second frame image set. The electronic device may obtain speech text 242 based on the partial speech data 222. The electronic device may obtain a representative frame image (e.g., the fourth frame image 214) of the second frame image set and the speech text 242 as one first content set 232.

FIG. 3 illustrates an example of an operation in which an electronic device obtains a content set from a digital document.

The electronic device may obtain one or more content sets from a digital document 310. Content set(s) obtained from the digital document 310 may be referred to as a second content set or a candidate second content set (or a candidate content set).

The digital document 310 may include a plurality of contents. Each content may include images and/or text. The electronic device may divide (e.g., group and/or separate) the plurality of contents included in the digital document 310 into one or more content sets. Dividing the digital document 310 may be interpreted as being substantially identical to dividing the plurality of contents included in the digital document 310.

The electronic device may divide the digital document 310 into a plurality of content sets based on at least one of a page and/or a section of the digital document 310. The digital document 310 may be composed of pages and/or sections. For example, the electronic device may group contents included in one page or a predetermined number of pages of the digital document 310 into one content set. For example, when it is determined that the digital document 310 may be divided into a plurality of sections, the electronic device may group contents included in one section or a predetermined number of sections into one content set.

The electronic device may divide the digital document 310 into content sets based on images included in the digital document 310. For example, the electronic device may, for each image included in the digital document 310, add text related to that image to a content set that includes that image. Text related to an image may include at least one of text describing the image, text having a similar meaning to the image, and/or text placed adjacent to the image.

The electronic device may generate, for each image included in the digital document 310, a content set including that image. The electronic device may, for each image, select text related to that image from among candidate texts included in the digital document 310. The electronic device may add the selected text to a content set that includes the corresponding image.

The electronic device may determine a relevance level between an image and a candidate text by using a relevance determination model. The relevance determination model may refer to a model generated and/or trained to output, from input data corresponding to an image and text, output data corresponding to a relevance level between the image and the text. The relevance determination model may be implemented based on at least one of a neural network (e.g., a CNN), a transformer, a large language model, a machine learning model, and/or a reinforcement learning model. The electronic device may select a candidate text having a relevance level, which indicates relevance to an image, greater than or equal to a threshold level as text and add the selected text to a content set that includes the image.

The electronic device may add text recognized from an image to a content set. For example, the electronic device may, for an image included in the digital document 310, add text recognized from the image to a content set that includes the image.

Referring to FIG. 3, the electronic device may divide a digital document 310 into a plurality of second content sets. A second content set 321 may include one or more images and a plurality of texts (e.g., text A1, text A2, and text A3). A second content set 322 may include one or more images and a plurality of texts (e.g., text B1, text B2, and text B3). A second content set 323 may include one or more images and a plurality of texts (e.g., text C1, text C2, and text C3).

FIG. 4 illustrates an example of an operation in which an electronic device determines a mapping relationship between a first content set and a second content set.

The electronic device may determine a mapping relationship between first content sets and second content sets.

The electronic device may, in response to a candidate second content set including an image, determine an image similarity level between a representative frame image of the first content set and an image of the candidate second content set.

Determining the image similarity level may be performed in the same or similar manner as determining the difference between the frame images as described above with reference to FIG. 2. The image similarity level may be determined by using an image similarity determination model. The image similarity determination model may refer to a model generated and/or trained to output, from input data corresponding to a first image and a second image, output data corresponding to an image similarity between the first image and the second image. The image similarity determination model may be implemented based on at least one of a neural network (e.g., a CNN), a transformer, a large language model, a machine learning model, and/or a reinforcement learning model.

The electronic device may, in response to the candidate second content set including text, determine a text similarity level between a partial speech of the first content set and the text of the candidate second content set. The text similarity level may be determined based on a character-level similarity and/or a semantic-level similarity, in the same or similar manner as the description above with reference to FIG. 2.

The electronic device may determine whether to map the candidate second content set as the second content set to the first content set, based on at least one of the determined image similarity level and/or the determined text similarity level.

When mapping the first content set to the second content set, the electronic device may map a plurality of content sets to one content set. For example, the electronic device may map two or more second content sets to one first content set and/or map one second content set to two or more first content sets.

Referring to FIG. 4, a description is mainly on an operation in which the electronic device determines, based on a specific first content set, a second content set from among second content sets (or candidate second content sets) that is similar to the specific first content set and subsequently maps the determined second content set to the first content set. However, examples are not limited thereto. For example, the electronic device may determine, based on a specific second content set, a first content set from among first content sets (or candidate first content sets) that is similar to the specific second content set and may subsequently map the determined first content set to the second content set.

For example, the electronic device may, in response to the second content set including an image, determine an image similarity level between an image of a candidate first content set (e.g., a representative frame image) and the image of the second content set. The electronic device may, in response to the second content set including text, determine a text similarity level between a partial speech of the candidate first content set and the text of the second content set. The electronic device may determine whether to map the candidate first content set as the first content set to the second content set, based on at least one of the determined image similarity level and/or the determined text similarity level. For example, the electronic device may map the first content set to the second content set when the image similarity level is greater than or equal to an image similarity threshold, and/or when the text similarity level is greater than or equal to a text similarity threshold.

Referring to FIG. 4, the electronic device may obtain first content sets 411, 412, and 413 obtained from a video and second content sets 421, 422, and 423 obtained as a result of dividing a digital document. The electronic device may determine, among the candidate second content sets, the second content set 421 and the second content set 422 as content sets similar to the first content set 411.

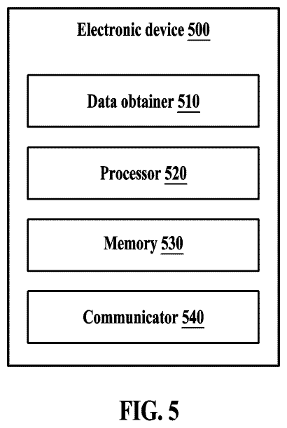

FIG. 5 illustrates an example of an electronic device.

An electronic device 500 may include a data obtainer 510, a processor 520 (e.g., one or more processors), a memory 530 (e.g., one or more memories), and a communicator 540.

The data obtainer 510 may obtain a video and/or a digital document. For example, the data obtainer 510 may be implemented as part or all of the communicator 540 and may obtain the video and/or the digital document from an external device through the communicator 540.

The processor 520 may obtain the first content set(s). The processor 520 may obtain the second content set(s). The processor 520 may determine a mapping relationship between the first content set(s) and the second content set(s). The processor 520 may generate text corresponding to an image included in the first content set or the second content set, based on the first content set and the second content set that are mapped to each other. The processor 520 may obtain the image and the generated text as an image-text pair. The processor 520 may include at least one processor including a processing circuit.

The memory 530 may temporarily and/or permanently store at least one of a video, a first content set, a digital document, a second content set, a mapping relationship between the first content set and the second content set, a generated text, and/or an image-text pair. The memory 530 may store instructions for an operation of obtaining the first content set, an operation of dividing the digital document into the second content set, an operation of mapping the first content set to the second content set, an operation of generating text, and/or an operation of obtaining the image-text pair. The instructions, when executed by the processor 520, may cause the electronic device 500 to perform operations directed by the instructions. For example, the memory 530 may be or include a non-transitory computer-readable storage medium storing code that, when executed by the processor 520, configures the processor 520 to perform any one, any combination, or all of the operations and/or methods disclosed herein with reference to FIGS. 1-4. However, these are only examples, and information stored in the memory 530 is not limited thereto.

The communicator 540 may transmit and receive at least one of the video, the first content set, the digital document, the second content set, the mapping relationship between the first content set and the second content set, the generated text, and/or the image-text pair. The communicator 540 may establish a wired communication channel and/or a wireless communication channel with the external device (e.g., a processing device, another electronic device, and a server) and may establish communication with the external device via, for example, cellular communication, short-range wireless communication, local area network (LAN) communication, Bluetooth™, wireless-fidelity (Wi-Fi) direct, and/or via a long-range communication network such as infrared data association (IrDA), a legacy cellular network, a fourth generation (4G) and/or fifth generation (5G) network, next-generation communication, the Internet, and/or a computer network (e.g., a LAN or a wide area network (WAN)).

The electronic devices, data obtainers, processors, memories, communicators, electronic device 500, data obtainer 510, processor 520, memory 530, and communicator 540 described herein, including descriptions with respect to respect to FIGS. 1-5, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-5 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
generating, from a video comprising speech data and a plurality of frame images, a first content set comprising a partial speech and a representative frame image;
separating a digital document related to the video into a plurality of candidate content sets;
mapping a second content set among the candidate content sets, which is related to the first content set, to the first content set;
generating text corresponding to the representative frame image of the first content set, based on the first content set and the second content set; and
generating an image-text pair comprising the representative frame image and the generated text.

2. The method of claim 1, wherein the generating of the first content set comprises:
generating speech text by converting the speech data into text;
grouping the plurality of frame images into a plurality of frame image sets; and
determining, for each frame image set, a representative frame image of the frame image set and a partial speech corresponding to the frame image set among the speech text as one first content set.

3. The method of claim 2, wherein the grouping of the plurality of frame images comprises:
determining a first representative frame image from among the plurality of frame images; and
based on a difference between the first representative frame image and a candidate frame image, performing either one of:
adding the candidate frame image to a first frame image set corresponding to the first representative frame image; or
determining the candidate frame image as a second representative frame image representing a second frame image set.

4. The method of claim 3, wherein the grouping of the plurality of frame images further comprises determining the difference between the first representative frame image and the candidate frame image based on a difference between pixel values of pixels of the determined first representative frame image and pixel values of pixels of the candidate frame image.

5. The method of claim 3, wherein the grouping of the plurality of frame images further comprises determining, based on a similarity level between first text recognized from the determined first representative frame image and second text recognized from the candidate frame image, the difference between the first representative frame image and the candidate frame image.

6. The method of claim 1, wherein the separating of the digital document comprises separating the digital document into a plurality of candidate content sets based on either one or both of a page and a section of the digital document.

7. The method of claim 1, wherein the separating of the digital document comprises adding, for each image of the digital document, text related to a corresponding image to a candidate content that comprises the corresponding image.

8. The method of claim 1, wherein the separating of the digital document comprises adding, for an image included in the digital document, text recognized from the image to a content set that comprises the image.

9. The method of claim 1, wherein the mapping of the second content set to the first content set comprises:
determining, in response to a candidate content set comprising an image, an image similarity level between the representative frame image of the first content set and the image of the candidate content set;
determining, in response to the candidate content set comprising text, a text similarity level between a partial speech of the first content set and the text of the candidate content set; and
determining whether to map the candidate content set as the second content set to the first content set, based on either one or both of the determined image similarity level and the determined text similarity level.

10. The method of claim 1, wherein the mapping of the second content set to the first content set comprises either one or both of:
mapping two or more second content sets to one first content set; and
mapping one second content set to two or more first content sets.

11. The method of claim 1, wherein the generating of the text comprises generating, by using a text generation model, any one or any combination of any two or more of caption text of the representative frame image, description text of the representative frame image, and question-answer text for the representative frame image.

12. The method of claim 1, wherein the generating of the text comprises:
determining an image type of the representative frame image or a partial image of the representative frame image from among a plurality of image types comprising a photo type, a table type, a diagram type, and a graph type; and
generating the text based on information on the determined image type.

13. The method of claim 1, further comprising training a vision language model by using a training data set comprising the generated image-text pair.

14. The method of claim 13, wherein the training of the vision language model comprises:
selecting a target image-text pair from among a plurality of candidate image-text pairs, based on any one or any combination of any two or more of a confidence level, a relevance level, and an image type of each candidate image-text pair; and
generating the training data set based on the selected target image-text pair.

15. The method of claim 1, further comprising:
extracting a partial image from the representative frame image of the first content set; and
generating the extracted partial image and text corresponding to the partial image as an image-text pair.

16. A non-transitory computer-readable storage medium storing code that, when executed by one or more processors, configure the one or more processors to perform the method of claim 1.

17. A processor-implemented method comprising:
generating candidate content sets from a video comprising speech data and a plurality of frame images, wherein each candidate content set comprises a partial speech and a representative frame image;
generating a second content set comprising a target image and text related to the target image from a digital document related to the video;
mapping a first content set among the candidate content sets, which is related to the second content set, to the second content set;
generating text corresponding to the target image of the second content set, based on the first content set and the second content set; and
generating an image-text pair comprising the target image and the generated text.

18. A processor-implemented method comprising:
generating text corresponding to an input image based on a result of applying a vision language model to the input image,
wherein the vision language model is trained using a training data set comprising a generated image-text pair,
wherein the image-text pair is generated by:
generating, from a video comprising speech data and a plurality of frame images, a first content set comprising a partial speech and a representative frame image;
separating a digital document related to the video into a plurality of candidate content sets;
mapping a second content set among the candidate content sets, which is related to the first content set, to the first content set;
generating text corresponding to the representative frame image of the first content set, based on the first content set and the second content set; and
generating the image-text pair to comprise the representative frame image and the generated text.

19. An electronic device comprising:
one or more processors configured to:
generate, from a video comprising speech data and a plurality of frame images, a first content set comprising a partial speech and a representative frame image;
separate a digital document related to the video into a plurality of candidate content sets;
map a second content set among the candidate content sets, which is related to the first content set, to the first content set;
generate text corresponding to the representative frame image of the first content set, based on the first content set and the second content set; and
generate an image-text pair comprising the representative frame image and the generated text.

20. The electronic device of claim 19, wherein the one or more processors are configured to:
generate speech text by converting the speech data into text;
group the plurality of frame images into a plurality of frame image sets; and
determine, for each frame image set, a representative frame image of the frame image set and a partial speech corresponding to the frame image set among the speech text as one first content set.
